(19) United States
(12) Patent Application Publication
(10) Pub. No.: US 2004/0204933 A1
(43) Pub. Date: Oct. 14, 2004

(54) Virtual microphone array

(75) Inventor: Michael Walker, Lichtenwald (DE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/812,066

(22) Filed: Mar. 30, 2004

(30) Foreign Application Priority Data
Mar. 31, 2003 (EP) 03 360 044.6

(51) Int. Cl. G10L 19/10

(52) U.S. Cl. 704/220

(57) ABSTRACT

A method for enhancing the quality of a received acoustic signal, in particular speech signal, wherein the received acoustic signal has been generated by a single microphone (=monaural signal), wherein the received acoustic signal is subjected to an analysis of characteristics is characterized in that the analysis is used to estimate one or more virtual microphone signals, which are parts of the received acoustic signal, and that the one or more virtual microphone signals are used to generate an enhanced quality acoustic signal, in particular with reduced echo and/or reduced reverberation compared to the received acoustic signal. The inventive method is useful for enhancing the quality of a sound signal recorded with one microphone, improving the intelligibility of speech in recordings and improving the reliability of speech control systems.

The invention is based on a priority application EP 03 360 044.6 which is hereby incorporated by reference.

### BACKGROUND OF THE INVENTION

The invention relates to a method for enhancing the quality of a received acoustic signal, in particular speech signal, wherein the received acoustic signal has been generated by a single microphone (=monaural signal), wherein the received acoustic signal is subjected to an analysis of characteristics.

Methods of this type are used e.g. in noise reduction systems, an example of which is disclosed in EP 1 278 185 A2.

Along with the advent of mobile telephony, the demand for high quality speech transmission has dramatically increased in order to offer high comfort to human telecommunication participants. Moreover, it is the intention of numerous engineers to control technical equipment by voice orders (speech control). This requires a high quality speech transmission in order to increase the reliability of speech recognition systems.

It is well known to apply noise reduction systems to speech signals. These noise reduction systems generally subtract estimated noise signals from the speech signals. It is also known to apply echo cancellation systems to remove echoes from the far end side in telecommunication systems, e.g. when a participant makes a hands-off phone call, i.e. without picking up the receiver, and a loudspeaker signal must be removed from a microphone signal superimposed with the loudspeaker signal, in particular to prevent feedback.

Kellermann (H. Teutsch, W. Kellermann, G. Elko, First and Second-order Adaptive Differential Nearfield/Farfield Microphone Arrays, IEEE—International Workshop on Acoustic Echo and Noise Control IWAENC, Sept. 10-13, 2001, Darmstadt, Germany) proposed to use an array of microphones in order to improve the quality of sound recordings. A number of microphones, disposed at different distances from the speaker, record independently a sound signal, and these sound signals are added, each with a time delay taking into account the running time of the sound to the different microphone positions. This technique is known as “beam forming”. Thus it is possible to increase the signal to noise (=S/N) ratio of the superimposed signal, compared to a single signal recorded with just one microphone.

But there is no enhancement for speech recorded by a single microphone. The speech quality depends, above all, on the local recording conditions, i.e. the distance and orientation of the speaker relative to the microphone and the room environment, in particular the sound reflection at walls or furniture as well as sound absorption. Sound reflection and absorption are typically frequency dependent. This influence of the room environment can be summarized as the reverberation conditions. Every recording not taking place in an absolutely sound absorbing environment (such as a studio) will be subject to reverberation. However, up to now there is no solution available for reducing the reverberation of a single microphone signal in arbitrary room environment.

### SUMMARY OF THE INVENTION

It is the object of the invention to offer a method for enhancing the quality of a sound signal recorded with one microphone, improving the intelligibility of speech in recordings and improving the reliability of speech control systems.

This object is achieved, in accordance with the invention, by a method as introduced above, characterized in that that the analysis is used to estimate one or more virtual microphone signals, which are parts of the received acoustic signal, and that the one or more virtual microphone signals are used to generate an enhanced quality acoustic signal, in particular with reduced echo and/or reduced reverberation compared to the received acoustic signal.

A recorded monaural signal s is composed of different parts (i.e. summands) s1, s2, s3, see FIG. 1. A human speaker generates some sound. This sound propagates (at the speed of sound) along different paths to the recording microphone. The shortest, and therefore fastest path is the direct way. The corresponding direct sound signal s1 is the first summand of the recorded signal s. Other paths include reflections of sound at walls. These propagation paths are longer, and therefore the corresponding signals s2, s3 arrive at the microphone later on, i.e. with a time delay. Signal s2, the signal arriving second at the microphone, has a time delay of d1 compared with s1. Signal s3, arriving third at the microphone, has a time delay of d2 compared with s2. In the example of FIG. 1, the recorded signal s has the summands s1, s2 and s3.

A sound signal s* almost identical with the recorded monaural signal s would be obtained if the recording was performed with three microphones at different distances to the speaker in an absolutely sound absorbing room and adding up these three microphone signals. The microphone nearest to the speaker would produce signal s1*, the second nearest s2* and the third nearest s3*. The distances of these microphones to the speaker would correspond to the lengths of the propagation paths of the sound signals s1, s2, s3 in the monaural recording illustrated in FIG. 1. Due to their existence only in thought, the three microphones in FIG. 2 are called virtual microphones.

The virtual microphone signals s1*, s2* and s3* themselves are per definition not subject to reverberation. Reverberation occurs only through adding up these signals to a single sound signal s*.

In order to obtain a signal free of reverberation, it is therefore necessary to determine one or several of the virtual microphone signals. Several virtual microphone signals may be used to increase the loudness level and/or the signal to noise ratio of a superimposed signal.

While the signals s1 and s1* are truly identical, the indirect signals s2, s3 and the higher order virtual microphone signals s2*, s3* are only approximately identical, since the indirect signals s2, s3 are subject to frequency-dependent reflections and absorption processes. In the context of this invention, however, the approximation is considered good enough to equate the indirect signals s1, s2, s3 with the corresponding higher order virtual microphone signals s1*, s2*, s3*, and it is therefore in the following simply referred to virtual microphone signals s1, s2, s3.

A highly preferred variant of the inventive method is characterized in

a) that the received acoustic signal is subjected to an analysis detecting the time period d1 between direct sound and the onset of reverberation sound within the received acoustic signal,

b) that a delay signal is generated by delaying the received acoustic signal by the time period d1,

c) that a modified delay signal is created by modifying the delay signal applying a set of modification parameters,

d) that a first virtual microphone signal is generated by subtracting the modified delay signal from the received acoustic signal,

e) that the first virtual microphone signal is subjected to an analysis generating one or several analysis parameters, and

f) that the modification parameters are adapted within a feedback loop, optimizing the analysis parameter(s), in particular minimizing the overall amplitude of the first virtual microphone signal.

This variant offers a method for explicitly determining the first virtual microphone signal, i.e. the signal of the virtual microphone closest to the speaker or sound source. The first virtual microphone signal is of particularly high quality, since it does not carry distortions in the frequency spectrum due to reflection or absorption of sound.

In a further development of this variant, the enhanced quality acoustic signal is generated by amplifying the level of the first virtual microphone signal, in particular to a normal loudness. In order to save time and equipment, it is dispensed with a calculation of the remaining virtual microphone signals, and the first virtual microphone signal is used as output. Normalization is useful since in general the level of one summand of a received acoustic signal is much lower than the level of the received acoustic signal. The normalization may be performed in the frequency domain or the time domain.

A further, highly preferred development for generating an nth virtual microphone signal, with n ∈IN, n≧2, is characterized in that an nth intermediate signal is generated by subtracting the first to (n−1)th virtual microphone signal from the received acoustic signal,

a′) that the nth intermediate signal is subjected to an analysis detecting the time period dn between the onset of sound and the onset of reverberation sound within the nth intermediate signal,

b′) that an nth delay signal is generated by delaying the nth intermediate signal by the time period dn,

c′) that an nth modified delay signal is generated by modifying the nth delay signal applying a set of modification parameters,

d′) that an nth virtual microphone signal is generated by subtracting the nth modified delay signal from the nth intermediate signal,

e′) that the nth virtual microphone signal is subjected to an analysis generating one or several analysis parameters, and

f′) that the modification parameters are adapted within a feedback loop, optimizing the analysis parameter(s), in particular minimizing the overall amplitude of the nth virtual microphone signal.

By means of this development, higher order virtual microphone signals may be generated. Detailed information about the room environment may be gathered on the basis of the higher order virtual microphone signals. This information can be useful for generating an enhanced quality acoustic signal. Since this calculation method requires the knowledge of the virtual microphone signals of all orders below the order to be calculated, the calculation starts with the second order and increases the order step by step. Note that limits can be introduced to stop calculation of (and thus neglect) higher order virtual microphone signals if the amplitude of an individual higher order virtual microphone signal drops below a minimum level. Note that dn denominates the time period between the (n−1)th and nth reverberation signal of the received acoustic signal.

Knowing higher order virtual microphone signals, a preferred further development of the inventive method is characterized in that the enhanced quality acoustic signal is generated by adding a number of N virtual microphone signals, with N ∈IN, N≧2, wherein the mth virtual microphone signal is delayed by a time period

$$tm = {\sum }_{i = m}^{N - 1} di ,$$

with m ∈[1, . . . , N−1], and the Nth virtual microphone signal is undelayed. In this way, the signal to noise ratio of the enhanced quality acoustic signal can be optimized. Note that the virtual microphone signals may be normalized in the time domain or the frequency domain before performing the adding.

Another development of the above mentioned variant of the inventive method provides that the modification in steps c) and/or c′) are performed by a finite impulse response unit, and wherein the modified time period of the finite impulse response unit is at least as long as the reverberation time of the received acoustic signal. A finite impulse unit can adapt the delayed acoustic signal to the room environment of the recording, including distortions due to frequency-dependent reflection or absorption and interference of different reverberation orders. In particular, the finite impulse response unit can correlate modification parameters with respect to earlier time sections of the modification. Most importantly, the FIR approach allows the removal of all reverberation from a signal within one subtraction cycle.

Preferably in a development of the inventive method, the determination of the analysis parameters in steps e) and/or e′) is performed by a least mean square method and/or a normalized least mean square method. The amplitude of the virtual microphone signal is minimized with the feedback loop leading to a minimization of the reverberation.

Also in accordance with the invention is a development wherein the received acoustic signal and/or the nth intermediate signal and/or the delayed signal and/or the nth delayed signal is/are subjected to a Fourier transformation, and the modification is performed in the frequency domain. This allows the application of spectral subtraction or spectral shaping, e.g. the E&M (Ephraim&Malah) algorithm or a Wiener Filter approach.

Another preferred development is characterized in that in steps a) and/or a′) the onset of the reverberating sound in the signal amplitude vs. time diagram of the received acoustic signal and/or nth intermediate signal is determined by observing an edge of the signal amplitude following a time period of substantially constant signal amplitude within a limited frequency interval, in particular within 100-300 Hz. In fast spoken human speech, each phoneme has a minimum duration on the order of 100 ms. In contrast, typical reverberation sound within a normal sized room occurs with a time delay on the order of only 10 to 20 ms. Thus, if e.g. the amplitude of a certain frequency block changes only 10 to 20 ms after its onset, the beginning of a reverberation can be assumed and in the above way easily determined.

An alternative variant of the inventive method of enhancing the quality of a speech signal is characterized in that

a start of the received acoustic signal is detected, and that the following steps are performed recursively in one or more cycles:

a) the stored signal, i.e. in the first cycle the received acoustic signal, else the processed signal derived in the preceding step c) to be further cleaned, is observed for a signal excitation indicating the start of a disturbing echo and/or reverberation signal;

b) the time delay d between the start of the received acoustic signal and the start of the disturbing echo and/or reverberation signal is determined, and the magnitude of the disturbing echo and/or reverberation signal is estimated;

c) a processed signal is generated by subtracting a compensation signal from the stored signal, wherein the compensation signal is derived from the stored signal by shifting the stored signal by the time delay and scaling the stored signal with the estimated magnitude,

wherein the processed signal of the last cycle is defined to be the first virtual microphone signal.

This variant allows the determination of the first virtual microphone signal in a different way. The reverberation signals are separately and subsequently subtracted from the received acoustic signal. In this method, the reverberation signals are approximated with the received acoustic signal, scaled down to a detected amplitude. This method neglects the distortions due to frequency dependent reflection or absorption or interference in indirect signals. It is therefore particularly suited for simple room environments. Of course, higher order virtual microphone signals may be calculated by subtracting all lower order virtual microphone signals from the received acoustic signal, and subjecting this difference signal to the same procedure as the received acoustic signal as described in this variant.

Also in the scope of the invention is an acoustic signal quality enhancement device, comprising means for performing an inventive method as described above.

Further in the scope of the invention is a computer terminal comprising an input for a received acoustic signal, in particular a microphone and/or a data carrier device and/or a data line, an output for an enhanced quality acoustic signal, in particular a loudspeaker and/or a data carrier device and/or a data line, and means for performing an inventive method as described above.

Further advantages can be extracted from the description and the enclosed drawing. The features mentioned above and below can be used in accordance with the invention either individually or collectively in any combination. The embodiments mentioned are not to be understood as exhaustive enumeration but rather have exemplary character for the description of the invention.

### BRIEF DESCRIPTION OF THE DRAWINGS

The invention is described in the drawings.

FIG. 1 shows a typical acoustic situation of a speaker in a room environment with reverberation;

FIG. 2 shows a virtual microphone array in accordance with the invention, corresponding to the acoustic situation of FIG. 1;

FIG. 3 shows a circuit for performing a variant of the inventive method for enhancing the quality of an acoustic signal based on a finite impulse response unit;

FIG. 4 shows a function detail of an FIR unit of FIG. 3;

FIG. 5 shows a circuit for performing an alternative method for enhancing the quality of an acoustic signal applying a recursive subtraction of single reverberation signals.

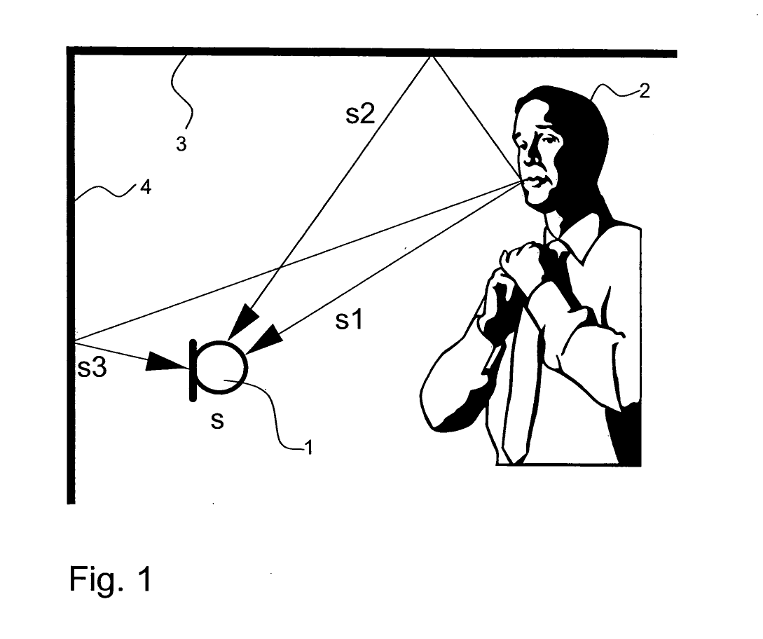

In FIG. 1, a typical acoustic situation when recording speech with a single microphone 1 is illustrated. A human speaker 2 speaks within a normal room environment, represented by room walls 3 and 4. The sound of his voice reaches the microphone 1 via three pathways. A first part s1 of his speech propagates to the microphone 1 on the direct way. A second part s2 of his speech is reflected by the top room wall 3 and then reaches the microphone 1. Signal s2 is therefore called an indirect signal. Since the signal path of s2 is longer than the signal path of s1, the signal s2 arrives at the microphone 1 with a time delay d1 compared with s1. A third part s3 of the human speaker 2's speech reaches the microphone 1 via a reflection at the left room wall 4. Signal s3, which also constitutes an indirect signal, has the longest signal path, and arrives at the microphone 1 with a time delay d2 compared to s2, or a time delay d1+d2 compared to s1. At the microphone 1, all signal parts s1, s2, s3 are detected in summary as a received acoustic signal s.

The indirect signals s2 and s3 thus superimpose the direct signal s1. In normal room environments, the time delays d1 and d2 are short compared with phonemes of human speech, and the signals s2, s3 which are echoes of the original speech are called reverberation signals. However, the reverberation constitutes a disturbance of the direct signal s1, deteriorating speech recognition and intelligibility.

In reality, of course, the received acoustic signal s is composed of much more parts, and only for simplification the description is limited to three summands s1, s2, s3. The signals s1, s2, s3 are complex signals generated by convoluting the original signal with the room environment.

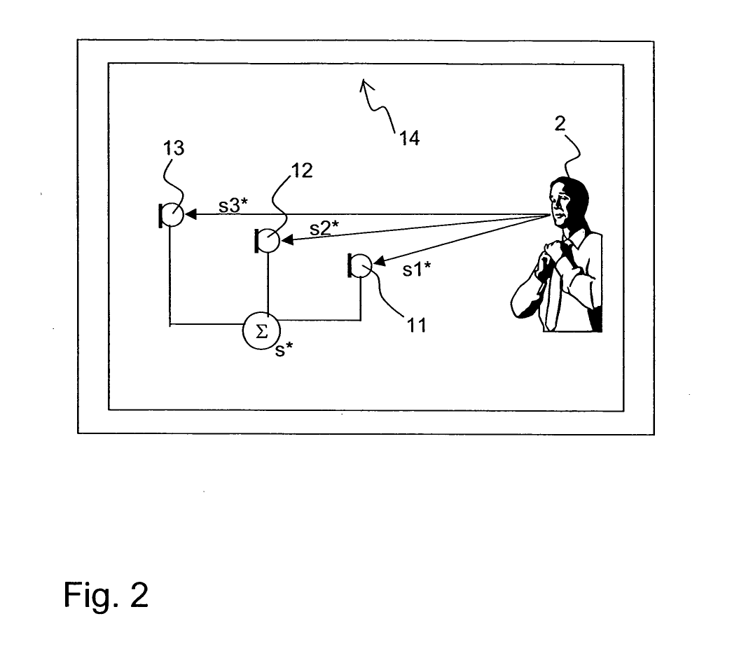

FIG. 2 shows a virtual microphone array corresponding to the acoustic situation of FIG. 1. In good approximation, the received acoustic signal s of the single microphone 1 of FIG. 1 is identical with a summary signal s* of an array of three virtual microphones 11, 12, 13 which are located in an absolutely sound absorbing room 14. The three virtual microphones 11, 12, 13 are positioned at different distances from the human speaker 2, wherein the signal path lengths of the signals s1*, s2*, s3* detected by the virtual microphones 11, 12, 13 are identical to the signal path lengths of the signals s1, s2, s3 in FIG. 1. The signals s1*, s2*, s3* are per definition free of any reverberation. Their only difference to the signals s1, s2, s3 is the absence of frequency distortions due to reflections or absorption in s2*, s3*. For this reason, the signal parts s1, s2, s3 are in the further description referred to as virtual microphone signals s1, s2, s3.

In order to obtain an acoustic signal free of reverberation, in accordance with the invention, it is necessary to determine one or more virtual microphone signals s1, s2, s3 out of the received acoustic signal s.

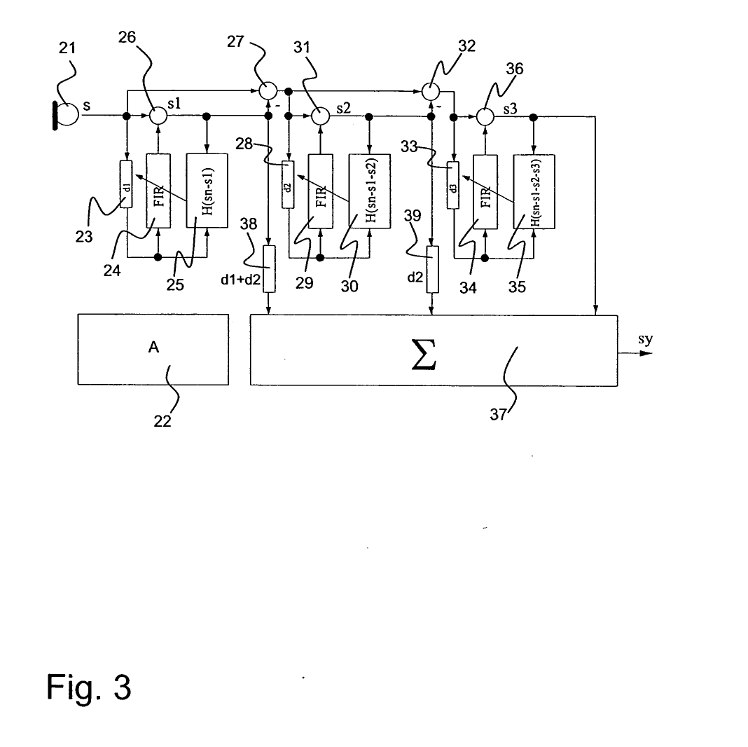

FIG. 3 shows a circuit diagram for generating the first three virtual microphone signals s1, s2, s3, using finite impulse response (FIR) units, and for generating a superposition signal sy, each out of a monaural received acoustic signal s.

A microphone 21 is positioned in a room environment and receives an acoustic signal s. The received acoustic signal s is subject to reverberation. Note that echo and reverberation, in principle, are identical effects, wherein echoes with delay times small compared to the duration of the original acoustic signal are commonly named as reverberation.

In order to extract a first virtual microphone signal s1 out of the received acoustic signal s, the received acoustic signal s is first analyzed in a delay analyzer 22, wherein the feeding line into the delay analyzer 22 is not shown in FIG. 3. The result of this analysis is the time delay d1 between the onset of the original sound and the onset of the first reverberation signal within the received acoustic signal s. The received acoustic signal s is then partially fed into a delay element 23, delaying said part of the received acoustic signal by d1. The delayed signal is then fed both into an FIR unit 24 and an analyzer unit 25. The FIR unit modifies the incoming delayed signal, applying a set of modification parameters which are set by the analysis unit 25.

The FIR unit 24 thus generates a modified delay signal that is correlated to, but not just proportional to, the delayed signal. In particular, the modified time period is long enough to cover the latest significant reverberation signal still. If e.g. the significant reverberation signals are found with onsets at 10 ms, 22 ms, and 35 ms after the onset of the original signal, then the modified time period must be at least 25 ms plus the time duration of the echo tail of the last reverberation, even though the undistorted time period d1 is only 10 ms. The undistorted time period d1 of the received acoustic signal is necessary to have an idea about the reverberation and its influence on the received acoustic signal later on. The modification takes into account that there are numerous reverberation signals superimposed which are part of the received acoustic signal and need to be subtracted. It also takes into account that there are frequency dependent distortions during reflections or absorption processes upon reverberation. In this way, the convolution of the indirect signals with the room environment is reproduced.

The modified delay signal is then subtracted from the received acoustic signal s in an adding element 26. The output of the adding element 26 delivers the first virtual microphone signal s1. However, the first virtual microphone signal s1 must be observed and optimized. For this purpose, part of the first virtual microphone signal s1 is fed into the analysis unit 26. Together with the information about the delay signal and the information of the undistorted received acoustic signal during the time period d1 following the onset of the original sound, the modification parameters of the FIR unit 24 are controlled by a feed-back algorithm. In the most simple case, the overall output of the first virtual microphone signal s1 is minimized by a least mean square algorithm.

The first virtual microphone signal s1 is then subtracted from the received acoustic signal s in an adding element 27. Since the resulting signal at the output of adding element 27 is intended for generating the second virtual microphone signal s2, it is called the second intermediate signal. The second intermediate signal therefore consists of all reverberation signals, but not of the direct acoustic signal; i.e. the second intermediate signal is s-s1.

The first sound of the second intermediate signal is the onset of the first reverberation signal of the received acoustic signal s. The delay analyzer 22 determines the time duration d2 between the onset of this first sound and the next reverberation signal within the second intermediate signal, i.e. the time period d2 between the onsets of the first and second reverberation of the received acoustic signal s. This determination is preferably performed with the second intermediate signal, but may already have been performed with the received acoustic signal s.

The second intermediate signal is then processed in the same way as the received acoustic signal s has been. Part of the second intermediate signal is delayed by the time period d2 in a delay element 28, generating a second delay signal. This second delay signal is then modified within an FIR unit 29 which is controlled by an analyzer unit 30. The second modified delay signal, generated by the FIR unit 29, is subtracted from the second intermediate signal in an adding element 31. The output of the adding element 31 provides the second virtual microphone signal s2. The second virtual microphone signal s2 is partially fed into the analyzer unit 30 in order to allow a feedback control of the FIR unit 29.

The second virtual microphone signal is then subtracted from the second intermediate signal in an adding element 32. Thus, a third intermediate signal is generated at the output of the adding element 32. The third intermediate signal is therefore s-s1-s2.

The third intermediate signal has as its first sound the onset of the second reverberation of the received acoustic signal s. A time delay d3 between the onset of sound and the next reverberation sound in the third intermediate signal is then determined by the delay analyzer 22, i.e. the time duration d3 between the second reverberation and the third reverberation of the received acoustic signal s is determined.

The third intermediate signal is then processed in the same way as the received acoustic signal s or the second intermediate signal have been. Part of the third intermediate signal is delayed by the time period d3 in a delay element 33, generating a third delay signal. This third delay signal is then modified within an FIR unit 34 which is controlled by an analyzer unit 35. The third modified delay signal, generated by the FIR unit 34, is subtracted from the third intermediate signal in an adding element 36. The output of the adding element 36 provides the third virtual microphone signal s3. The third virtual microphone signal s3 is partially fed into the analyzer unit 35 in order to allow a feedback control of the FIR unit 34.

Although each virtual microphone signal s1, s2, s3 could be used for further processing, in the circuit of FIG. 3, a summary signal sy is generated by adding up the three virtual microphone signals s1, s2, s3 in an adding element 37. In order to have the useful first sound at the same time position in each added virtual microphone signal, the first virtual microphone signal is delayed by the time d1+d2 in a delay element 38. This is the time elapsed between the onset of direct sound in the received acoustic signal s—which is the onset of sound in s1 —and the onset of the second reverberation in the received acoustic signal s—which is the onset of sound in s3. The second virtual microphone signal s2 is delayed by d2 in a delay element 39. This is the time elapsed between the onset of the first reverberation in the received acoustic signal s—which is the onset of sound in s2—and the second reverberation in the received acoustic signal s—which is the onset of sound in s3. Thus, all added virtual microphone signals have their onset of sound at the time position of the onset of the second reverberation in the received acoustic signal s.

The adding leads to an excellent signal to noise ratio of the summarized signal sy. The summarized signal sy is also free of reverberation.

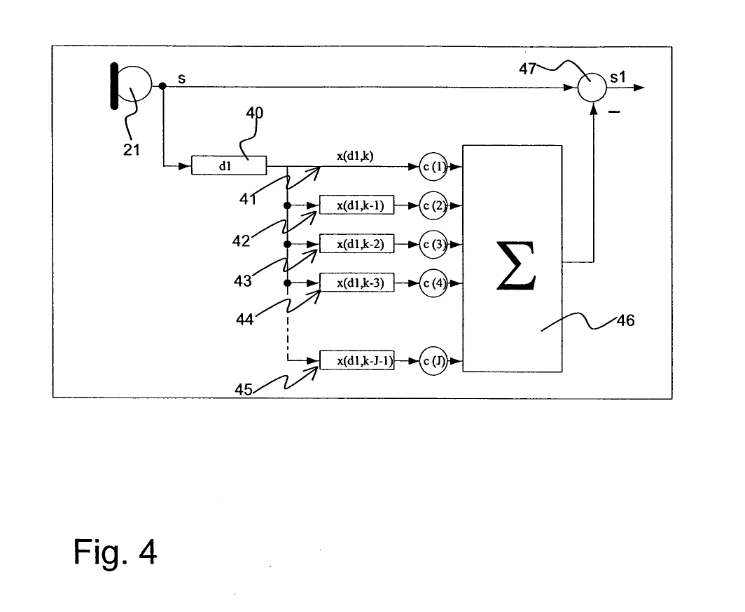

FIG. 4 illustrates the modification of part of the received acoustic signal s in order to generate a first virtual microphone signal s1, i.e. the direct signal without reverberation influence, by an FIR unit. The received acoustic signal s, generated by a microphone 21, is tapped, delayed by d1 in a delay element 40 and fed into a number of J stages 41 to 45. The first, top stage 41 chooses the first time slot k within the FIR unit. The signal amplitude x(d1, k) of the first time slot k is multiplied with a first adjustable filter coefficient c(1) and provided to a summary unit 46. A second time slot k-1 is chosen in a second stage 42, and its signal amplitude x(d1, k-1) is multiplied with a second adjustable filter coefficient c(2). The multiplied signal amplitude of the second time slot k-1 is also provided to the summary unit 46. Analogously, all time slots k to k-(J-1) of the FIR unit are processed, and their signal amplitudes are provided to the summary unit 46. The summary unit 46 puts together the signal amplitudes of the time slots to form a modified delay signal. In an adding element 47, the modified delay signal is subtracted from the received acoustic signal s in order to generate a first virtual microphone signal s1.

The first virtual microphone signal s1 is tapped and analyzed in order to obtain feedback control information for the adjustable filter coefficients c(1) to c(J). The analysis tool and the feedback loop are not shown in FIG. 4.

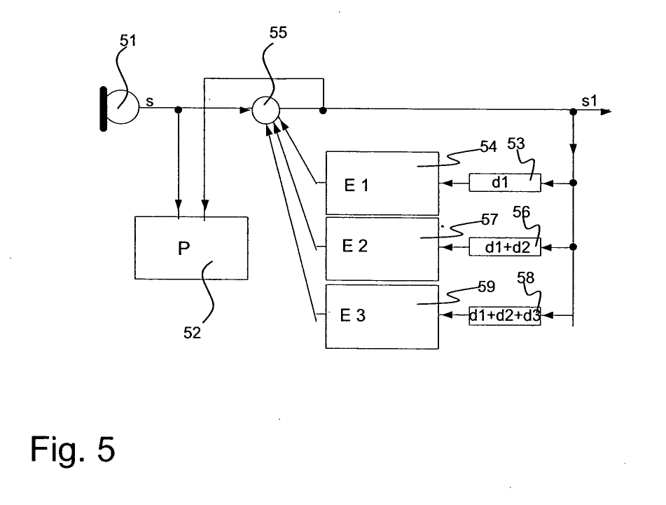

In FIG. 5, a second approach to obtain a first virtual microphone signal s1, based on recursively subtracting echo or reverberation signals, is illustrated.

At a microphone 51, a received acoustic signal s is generated. A parameterization unit 52 analyzes the received acoustic signal s, looking for the time period d1 between the onset of the original sound and the onset of the first reverberation signal, and the amplitude of the first reverberation signal. This information is given to a first cycle subtraction stage, comprising a delay element 53 and an attenuation/amplification unit 54. The received acoustic signal s is feed via junction 55 into the first cycle subtraction stage, namely into the delay element 53. This delay element 53 is adjusted to the first delay time d1. Subsequently, the amplitude of the delayed signal is adjusted by the attenuation/amplification unit 54 to the level determined by the parameterization unit 52. The resulting compensation signal is then subtracted from the received acoustic signal s at the junction 55. The output of the junction 55 provides a first cycle processed signal.

The first cycle processed signal consists of the direct signal and the second and later reverberation signals. The first reverberation signal has been subtracted in good approximation. The approximation assumes that the reverberation or echo sound is very similar to the original sound, differing only in amplitude and onset time.

The first cycle processed signal is then analyzed in the parameterization unit 52 again, in order to estimate the time period d1+d2 between the onset of the original sound and the onset of the next uncompensated (i.e. the second) reverberation echo, and the amplitude of the second reverberation echo is estimated. This information is given to a second cycle subtraction stage. In the second cycle subtraction stage, comprising a delay element 56 and an attenuation/amplification unit 57, a second cycle compensation signal is generated subtracted from the first cycle processed signal, resulting in a second cycle processed signal. The second cycle processed signal consists of the direct signal and reverberation signals of third and higher order.

Analogously, a third cycle compensation signal is subtracted from the second cycle processed signal in a third cycle subtraction stage, consisting of a delay element 58 and a attenuation/amplification element 59. This results in a third cycle processed signal. In the circuit shown in FIG. 5, later reverberation signals or echoes are neglected, and the third cycle processed signal is considered as the first virtual microphone signal s1 to be lead out. The signal s1 in FIG. 1 therefore consists of the direct signal and reverberation signals of fourth and later order, wherein the reverberation signals of fourth and higher order are assumed to be negligibly weak.

In the following, the ideas of the invention is described in further detail.

As the basic idea of the invention, room reverberation can be considered as a microphone array with an unknown number of microphones having unknown distances to the speech signal to be recorded. The recorded signal is a superposition of several sources leading to a microphone signal s(k) corresponding a sum of a number I of reflections, with k: time index. The situation for I=3 is illustrated in FIG. 1.

$$s ( k ) = {\sum }_{i = 1}^{I} s i ( k ) \qquad ( 1 )$$

The first step of the basic idea is to remove reflections from the microphone signal s(k) in order to obtain the clean speech signal s1 (k) equivalent with a first virtual microphone having the shortest distance to the speech source, compare FIG. 2. It can be generated by reflection if the subscriber is out of the reverberation or directly by the subscriber himself.

$$s1 ( k ) = s ( k ) - {\sum }_{i = 2}^{I} s i ( k ) \qquad ( 2 )$$

The room reverberation corresponding to the sum I except the first microphone can be eliminated, if the delay d1 and the magnitude m1 of a first reflector is known.

With the first clean signal s1 (k), the second clean signal s2(k) can be computed.

$$s2 ( k ) = s ( k ) - s1 ( k ) - {\sum }_{i = 3}^{I} s i ( k ) \qquad ( 3 )$$

s2(k) will need another delay d2 and another rest response behaviour, to be observed with the same rules as explained above. In further steps, the rest signal can be processed in the same way to compute the clean signal of a third or I'th source.

$$sI ( k ) = s ( k ) - {\sum }_{i = 1}^{I - 1} s i ( k ) \qquad ( 4 )$$

With the described algorithm, a number I of sources can be computed, correlated and superimposed in order to increase the S/N.

$$\begin{matrix}s y ( k ) = s1 [ k - d1 - d2 - … - d ( I - 1 ) ] + \\ s2 [ k - d2 - … - d ( I - 1 ) ] + … + s I ( k ) \\ = s y ( k ) \\ = {\sum }_{i = 1}^{I - 1} [ s i ( k - {\sum }_{r = i}^{I - 1} d r ) ] - s I ( k )\end{matrix} \qquad ( 5 )$$

with r: counting index.

The de-reverberated signals will have a frequency response dependent on the size, surface and material of the reflector. Thus, after the reconstruction of the clean speech signals, a compensation of the frequency response might become necessary. Furthermore, the signal level can be amplified to a normal loudness, using compander technique. Both additional functions can be carried out in time and/or frequency domain.

Two approaches for the echo subtraction are feasible. A first approach is based on FIR. In the time domain we can use an FIR filter for the reconstruction of the reverberated signal, as a short clean signal until the detection of the reverberation is available. This signal is convoluted with the room impulse response, characterised by the filter coefficients c(j) with the length J, i.e. with J: number of time slots within the FIR filter, and j: time slot index.

$$s1 ( k ) = s ( k ) - {\sum }_{j = 1}^{J} s ( j , k - d1 ) \cdot c ( j ) \qquad ( 6 )$$

The computation of c(j) can be carried out by NLMS or faster RLS algorithms, whereas the coefficients have to be computed in the short time slot provided by d1. Thus the coefficient adaptation must be controlled by a voice activity detector (VAD) and d1.

Another approach is based on spectral subtraction. Echo subtraction may also be carried out in the frequency domain based on one of many available methods (E&M, Wiener Filter, . . . ), whereas the time window of interest can be determine according to below mentioned methods. An example for the for the Wiener Filter approach is shown in equation (7).

$${H}_{( s1 , n , k )} = \{ \begin{matrix}1 - {( \frac{{s}_{( n , k - d1 )}}{\vert {X}_{( s , n )} \vert} )}^{2} if ( \vert {X}_{( s , n )} \vert > {s}_{( n , k - d1 )} ) \\ EFL else\end{matrix} \qquad ( 7 )$$

H(s1,n,k)=transfer function

s(n,k-d1)=estimated reverberation signal

IX(s,n)I=absolute value of X(s1,n)

EFL=echo floor

with n: frequency index and X: amplitude.

One of the premises for the application of the inventive method is to find and estimate the reverberation signals. The first reflector can be observed in the frequency domain by the unnatural spectral excitation after speech became active. The excitation of a certain frequency follows in an un-echoic room natural rules. At the beginning of speech activity, it can be expected, that the absolute magnitude of the excited frequency bin (IX(n)I) increases, and holds then its magnitude for a certain frequency dependent time. E.g. basic frequencies of speech between 100 . . . 300 Hz are excited for fast spoken speech at least 100 ms.

A reflector in a room with a distance d<6,6 m to the microphone introduces a fast change of the magnitude (IX(n)I) in less than 20 ms. Another indicator is the phase of the signal which changes rapidly after a reflection reaches the microphone, superimposing the microphone signal.

So far, reverberation has been an unsolved problem, which influences the quality of all telecommunication systems. This invention is a solution for an extreme wide application field with following advantages: high speech quality in spite of poor recordings; high reliability for speech recognition systems; adaptive speech enhancement; extremely broad application environment; software solutions based on the inventive method are extremely cheap, whereas hardware microphone techniques will stay expensive.

1. Method for enhancing the quality of a received acoustic signal, in particular speech signal, wherein the received acoustic signal has been generated by a single microphone, wherein the received acoustic signal is subjected to an analysis of characteristics,
wherein
the analysis is used to estimate one or more virtual microphone signals, which are parts of the received acoustic signal, and the one or more virtual microphone signals are used to generate an enhanced quality acoustic signal, in particular with reduced echo and/or reduced reverberation compared to the received acoustic signal.

2. Method according to claim 1,
wherein
a) the received acoustic signal is subjected to an analysis detecting the time period d1 between direct sound and the onset of reverberation sound within the received acoustic signal,
b) a delay signal is generated by delaying the received acoustic signal by the time period d1,
c) a modified delay signal is created by modifying the delay signal applying a set of modification parameters,
d) a first virtual microphone signal is generated by subtracting the modified delay signal from the received acoustic signal,
e) the first virtual microphone signal is subjected to an analysis generating one or several analysis parameters, and
f) the modification parameters are adapted within a feedback loop, optimizing the analysis parameter, in particular minimizing the overall amplitude of the first virtual microphone signal.

3. Method according to claim 2, wherein the enhanced quality acoustic signal is generated by amplifying the level of the first virtual microphone signal, in particular to a normal loudness.

4. Method according to claim 2 for generating an nth virtual microphone signal, with n ∈IN, n≧2, wherein
an nth intermediate signal is generated by subtracting the first to (n−1)th virtual microphone signal from the received acoustic signal,
a′) the nth intermediate signal is subjected to an analysis detecting the time period dn between the onset of sound and the onset of reverberation sound within the nth intermediate signal,
b′) an nth delay signal is generated by delaying the nth intermediate signal by the time period dn,
c′) an nth modified delay signal is generated by modifying the nth delay signal applying a set of modification parameters,
d′) an nth virtual microphone signal is generated by subtracting the nth modified delay signal from the nth intermediate signal,
e′) the nth virtual microphone signal is subjected to an analysis generating one or several analysis parameters, and
f′) the modification parameters are adapted within a feedback loop, optimizing the analysis parameter, in particular minimizing the overall amplitude of the nth virtual microphone signal.

5. Method according to claim 4, wherein the enhanced quality acoustic signal is generated by adding a number of N virtual microphone signals, with N ∈ IN, N≧2, wherein the mth virtual microphone signal is delayed by a time period
$$tm = {\sum }_{i = m}^{N - 1} di ,$$
with m ∈[1, . . . , N−1], and the Nth virtual microphone signal is undelayed.

6. Method according to claim 4, wherein the modification in steps c) and/or c′) is performed by a finite impulse response unit, and wherein the modified time period of the finite impulse response unit is at least as long as the reverberation time of the received acoustic signal.

7. Method according to claim 4, wherein the determination of the analysis parameters in steps e), and/or e′) is performed by a least mean square method and/or a normalized least mean square method.

8. Method according to claim 4, wherein the received acoustic signal and/or the nth intermediate signal and/or the delayed signal and/or the nth delayed signal is/are subjected to a Fourier transformation, and the modification is performed in the frequency domain.

9. Method according to claim 4, wherein in steps a) and/or a′) the onset of the reverberating sound in the signal amplitude vs. time diagram of the received acoustic signal and/or nth intermediate signal is determined by observing an edge of the signal amplitude following a time period of substantially constant signal amplitude within a limited frequency interval, in particular within 100-300 Hz.

10. Method according to claim 1, wherein a start of the received acoustic signal is detected, and that the following steps are performed recursively in one or more cycles:
a) observing the stored signal, i.e. in the first cycle the received acoustic signal, else the processed signal derived in the preceding step c) to be further cleaned, for a signal excitation indicating the start of a disturbing echo and/or reverberation signal;
b) determining the time delay d between the start of the received acoustic signal and the start of the disturbing echo and/or reverberation signal, and estimating the magnitude of the disturbing echo and/or reverberation signal;
c) generating a processed signal by subtracting a compensation signal from the stored signal, wherein the compensation signal is derived from the stored signal by shifting the stored signal by the time delay d and scaling the stored signal with the estimated magnitude,
wherein the processed signal of the last cycle is defined to be the first virtual microphone signal.

11. An acoustic signal quality enhancement device, comprising means for performing a method according to claim 1.

12. A computer terminal comprising an input for a received acoustic signal, in particular a microphone and/or a data carrier device and/or a data line, an output for an enhanced quality acoustic signal, in particular a loudspeaker and/or a data carrier device and/or a data line, and means for performing a method according to claim 1.
